(19) United States
(12) Patent Application Publication
(10) Pub. No.: US 2010/0134232 A1
(43) Pub. Date: Jun. 3, 2010

(54) ELECTRIC COMPONENT WITH WINDING AND TAPPING

(75) Inventors: Karl Zillmann, Marsberg (DE); Dietmar Krefeld, Brilon (DE)

Correspondence Address: Darby & Darby, P.O. Box 770, Church Street Station, New York, NY, 10008-0770, US

(73) Assignee: ABB TECHNOLOGY AG, Zurich (CH)

(21) Appl. No.: 12/595,425

(22) PCT Filed: Apr. 11, 2008
(86) PCT No.: PCT/EP2008/002873

§ 371 Date: Oct. 9, 2009

(30) Foreign Application Priority Data
Apr. 14, 2007 (DE) 10 2007 017 702.1

(51) Int. Cl. H01F 27/29; H01F 41/06; H01F 41/10

(52) U.S. Cl. 336/192; 29/602.1; 29/729; 29/747

(57) ABSTRACT

A power transformer includes at least one winding formed from at least one conductor extending along a circumferential direction, wherein the at least one winding has a tap in a contact section formed by a profile of the at least one conductor in at least one direction inclined relative to the circumferential direction; and at least one supporting element configured to support the conductor in the contact section.

This is a U.S. National Phase Application under 35 U.S.C. §171 of International Application No. PCT/EP2008/002873, filed on Apr. 11, 2008, which claims priority to German Patent Application No. DE 10 2007 017 702.1, filed on Apr. 14, 2007, both incorporated by reference herein. The International Application was published in German on Oct. 23, 2008 as WO 2008/125288 under PCT Article 21 (2).

The invention relates to the provision of a tap in a winding of an electrical component. In particular, the invention relates to electrical high-power transformers or inductors with a better tapping structure.

### BACKGROUND

Electrical components comprise windings in order to produce magnetic fields, or in order to convert electromagnetic fields to power. The main fields of use of a component such as this with windings are transformers which allow voltage and current conversions, by means of primary and secondary windings. Furthermore, windings are used in inductors in order to influence the current flow, as a phase shifter, by the building up and running down of magnetic fields. Said components are used to influence the flow of electrical power while, in contrast, for example, electromagnets and electrical machines are used as further examples for components with windings, in order to convert electrical power to mechanical power or force.

The invention is used primarily in transformers. These comprise primary windings which produce an alternating magnetic field in a magnet, which induces a voltage in secondary windings. A further field of use of the invention is in the field of electrical machines in which a magnetic field which causes a rotary movement of a rotor is produced by means of windings through which current flows. In the opposite sense, an electrical machine can also convert mechanical rotation to electrical power. Furthermore, the winding in a solenoid is used to produce a magnetic field which causes a linear movement of a magnetic object.

In order to reduce the physical size and concentration of the magnetic field, the conductor which is carrying the electric current is wound in the form of a coil, for example around a cavity or preferably around a magnetic material which is in the form of a magnet core, in order to guide the magnetic field.

In general, a winding is in the form of a ring with a rectangular cross section, which is formed by a conductor wound in a multiplicity of turns and distributed uniformly. In addition to the two end connections of the conductor, it is expedient in many fields for contact also to be made with the conductor at a point between the ends by means of a tap, for example for flexible operation using different operating voltages/currents, as redundancy in case a winding section fails, for assignment of different functions to different winding sections, or for similar reasons. In order to fit such taps, the winding process, which is based on the rotation of a winding former or of a wire guide, is interrupted in order to make contact with the conductor between the two conductor ends. The uppermost winding, that is to say the conductor point which is closest to the conductor section which was wound most recently, is then soldered to a tapping conductor, and the solder point is electrically insulated, before the winding process is continued.

This discontinuous process leads to relatively long pauses during the winding process, and thus to ineffective utilization of the winding machines, thus incurring high production costs.

### SUMMARY OF THE INVENTION

An aspect of the present invention is therefore to provide a better mechanism for the tapping of windings of electrical components, by means of which the winding process can be improved.

The invention is based on the inventive concept according to which the conductor which forms the winding can also be used as at least part of the tapping conductor at the tapping point and, accordingly, can be curved at the tapping point, inclined with respect to the rest of the winding profile. According to the invention, in a contact section at which the tap is intended to be produced, the conductor leaves the circumferential direction which normally exists there in order to form a closed or open loop and, after the contact section, follows the winding profile in the predetermined circumferential direction. In this way, the conductor which is used to form the winding forms a part of the tapping conductor within the contact section, and this is passed out of the winding.

Taps can therefore be provided only by special guidance of the conductor during the winding process. The introduction of taps therefore requires only process steps, measures and tools which are already used during the winding process. The interruption in the winding process is therefore minimal, and there is no need to use special tools for production of the tap during the winding process, for example soldering appliances, welders, apparatuses for insulation of the tap, screwing or drilling apparatuses, appliances for fitting of terminals, or the like. The implementation of the invention requires only modified operation of the winding apparatus, which guides the conductor around the winding or around the winding core, in order to carry out specific radial and/or axial movements, by means of which the tap is formed.

The profile of the conductor in the contact section preferably corresponds to an at least partially closed curve, for example a U, a circle section or an ellipse section. Within the contact section, the conductor may also have different shapes in places, in which case sections of the conductor may be arranged parallel to one another.

The point at which the inclination of the conductor starts, that is to say one end of the contact section, is preferably only a short distance away from the other end of the contact section, that is to say from the point at which the winding is continued. The loop or lug formed in this way preferably has a length which allows a part of the loop or lug to be removed from the winding. A portion of the loop is therefore available for making external contact, after completion of the winding. Alternatively, the winding can be offset at one end of the contact section by a distance with respect to the winding at the other end of the contact section, which distance extends parallel to a longitudinal axis of the winding. As used herein, parallel means essentially parallel.

In one preferred embodiment, the curve has a section with an overall curvature of 270 degrees or more. This section is bounded by bend points which initiate the curvature into this section and change the conductor profile from the section which has an overall curvature of 270 degrees to a profile along the circumferential direction of the turn. The overall curvature within the section may also be more than 270 degrees, for example when the conductor is in the form of a Greek capital Omega within the contact section.

In one preferred embodiment, within the contact section, the conductor has a profile which is at right angles to the customary conductor profile, that is to say it is aligned at least in places at right angles to the profile of the conductor directly in front of the contact section. Outside the contact section, the conductor runs tangentially with respect to the circumferential direction of the conductor, and at right angles to the axis which is formed by the revolution of the conductor. Within the contact section, at least in places, the conductor projects radially from the electrical component with respect to this axis. Alternatively, within the contact section, the conductor runs at an angle or at least in places at right angles to the profile of the conductor outside the contact section and parallel to the axis which the conductor surrounds outside the contact section. Within the contact section, the conductor therefore runs at an angle to the profile of the conductor outside the contact section, and at least in places at right angles to or parallel to an axis of symmetry, that is to say an axis which is defined by the circumference of the winding.

If the winding is in the form of a column, for example a cylindrical winding, in which the turns form a hollow cylinder, the conductor or a section of the conductor within the contact section therefore runs either at right angles to the circumferential surface of the winding or parallel to the longitudinal axis of the winding (that is to say tangentially with respect to the circumferential surface), in order to form the tap at least in places.

According to one preferred embodiment of the invention, the winding of the electrical component according to the invention comprises at least one supporting element, which supports the conductor within the contact section. The conductor is guided in the form of a loop by the supporting element within the contact section, for example in a U shape, with the loop projecting radially with respect to an axis of symmetry of the winding. Alternatively, the supporting element may also be provided parallel to an axis of symmetry of the winding, such that, in the contact section, the conductor runs at right angles to the circumferential direction and parallel to a longitudinal axis of the winding, and partially projects from a head surface or bottom surface of the winding. The use of the supporting element improves the mechanical robustness within the contact section. Furthermore, the supporting element can be used for shaping of the conductor profile within the contact section during the course of the winding process.

According to a further embodiment of the invention, the winding profile is continued at one end of the contact section in the same way as that provided by the winding profile at the other end of the contact section, to be precise with the same shape and at the same point as that governed by the profile of the turn before the contact section. Alternatively, the winding profile can be offset at one end of the contact section in the axial direction with respect to the winding profile at the other end of the contact section. For example, one end of the contact section can be provided at a specific height between a head surface or bottom surface, for example in the center, while the other end of the contact section is provided adjacent to the head surface or adjacent to the bottom surface of the winding. By way of example, this is achieved by guiding the conductor at a first axial height before the formation of the tap and then, on reaching the contact section, by forming the tap by appropriate guidance of the conductor, and then continuing the winding at a second axial height after the formation of the tap, with this second axial height not being the same as the first. In order to compensate for the winding gap that this results in, a winding section, for example with the same thickness as one turn, can then be introduced into this winding gap.

The electrical component may be a high-power transformer which, for example, comprises three windings which form a three-phase system. The high-power transformer preferably comprises a high-voltage side and a low-voltage side, which each comprise three windings and which are each interconnected in delta or star. In addition to the windings, the high-power transformer furthermore comprises an iron core, which is used as a yoke for magnetic connection of the windings. In one preferred embodiment, the electrical component is a high-power transformer with three winding blocks, in the interior of each of which there is a magnetic core, with the cores being connected to one another via a respective yoke on its upper face and lower face. A winding block of a transformer comprises an outer high-voltage winding and an inner low-voltage winding, which concentrically surrounds the respective magnetic core. In one preferred embodiment, an annular space for axial cooling channels is provided between the high-voltage winding and the low-voltage winding. The taps and the conductors leading to the taps can be provided in these cooling channels, with the taps being formed from conductors of the high-voltage winding or of the low-voltage winding, or from both windings.

In a further embodiment, the electrical component is provided as an inductor, which is formed by the winding. The inductor may be formed from one winding with one core, or from three windings with one core. Depending on the circuitry, winding parts can be connected as inductors which are connected to the high-power transformer in parallel or in series.

According to a further preferred embodiment, the electrical component is an electrical high-power magnet or an electrical high-power machine. In the case of the magnet, the winding preferably has an annular shape with a rectangular cross section along a plane which runs parallel to the longitudinal axis (longitudinal cross section), in which case the winding can be subdivided into different sections by means of the tapping structure as described above, in order to allow different operating voltages or operating levels. Although, in principle, the winding structure of electrical machines may differ from the winding structure of transformers, inductors or magnets, it is possible to provide a tap as described above for electrical machines as well. In this case, the winding direction that exists on the contact section is used instead of the circumferential direction, if the windings are not in the form of a ring with a rectangular longitudinal cross section.

The inductors, transformers, electrical magnets or electrical machines mentioned above are preferably intended for high power ratings of more than 1 kVA, preferably for ratings of more than 10 kVA and in particular for ratings of more than 250 kVA. The rated operating voltage, the high-voltage side in the case of transformers, is at least 230 V, preferably at least 1 kV, and in particular at least 10 kV.

According to a further aspect of the present invention, a method is provided for production of an electrical component which comprises a winding with a tap, with the conductor being wound around a rotation axis and with taps being added, by guiding the conductor in a direction which is inclined with respect to the circumferential direction which is used during the winding of the conductor.

Taps can accordingly be provided as described above by bending the conductor to form a loop. The conductor is wound around a rotation axis before or after producing the loop. This is preferably done by guiding the conductor appropriately eccentrically around a rotation axis, that is to say periodically between an upper axial end and a lower axial end, with the radial distance from the axis increasing continuously. In one embodiment, a stationary winding former is used around which the wire is guided radially at a distance from a rotation axis. The wire guide would therefore rotate at a radial distance from a rotation axis, with the radial distance increasing slowly and continuously in order to take account of the increasing winding diameter. At the same time, the wire is passed backward and forward periodically in the axial direction between an upper and a lower end.

Alternatively, the guide for the wire does not carry out a rotary movement and a rotating winding former is used for the corresponding winding, with the wire guide carrying out only the periodic axial and slow continuously radial movement as described above. In a further embodiment, the wire guide carries out only the periodic axial movement, with the holder for the resultant winding former carrying out at least one other of the movements as described above, in a corresponding manner. In a further embodiment, the conductor is wound by means of a stationary guide, with a winding apparatus carrying out the movement components mentioned above. In principle, the movement components mentioned above can be individually and partially or completely associated with the guidance of the line or of the movement of the winding. According to the invention, an apparatus can be used which is inserted between the conductor guide and the corresponding winding, and/or its holder for guiding the conductor, and is designed to carry out the movements of the conductor guide and/or of the winding former that are required to carry out the tapping, that is to say to form a loop. For example, the corresponding winding may carry out only a rotary movement and a conductor guide may carry out a periodic axial and continuous radial movement, in order to form the winding, with an apparatus which is provided between the winding and the conductor guide carrying out the axial and/or radial movements in order to form a loop which extends at least partially radially from the longitudinal axis of the winding, or which extends at least partially parallel to the longitudinal axis.

During the winding process for high-power transformers, the winding that has already been created does not carry out any rotary movement, in order to prevent the heavy weight and therefore the flywheel mass of the resultant winding disadvantageously influencing the control of the winding process and the mechanical stress in the wound line.

In one preferred embodiment of the method, in order to form the tap, the conductor is guided in a direction which on the one hand is at right angles to the local circumferential direction. On the other hand, the conductor is at the same time guided in a direction which is at right angles to the circumferential direction, parallel to the circumferential direction, or is a linear combination of these directions.

In a further embodiment of the method, for production of a winding which is bounded in the axial direction, the tap is provided in that the conductor is passed out parallel to the rotation axis and inclined with respect to the local circumferential direction via a point which marks the boundary of the winding in the axial direction. A boundary such as this is, for example, marked by a head end, a head surface or a bottom surface of the winding. This allows contact to be made with the tap without having to change the completely wound winding.

In a further embodiment, the tap is provided in that the conductor is passed out in the radial direction over a distance which corresponds to the external surface of the winding after completion. This likewise means that the tap can be connected, for example, to a tap line without changing the winding.

The tap is preferably provided between the two ends of the line which is shaped to form the winding. Alternatively, however, that end which is on the inside in the radial direction and/or the end which is on the outside can also be provided as a tap according to the invention.

In a preferred embodiment, the component comprises two concentric windings which each have a winding end on the winding side which is adjacent to the other winding, that is to say at the point at which the two windings meet one another or are opposite one another, separated via a cooling channel. In this preferred embodiment, these two inner winding ends are likewise in the form of taps since their conductors are inclined with respect to the circumferential direction. However, in this case, the tap is not in the form of a partially closed curve but a line section which runs transversely with respect to the circumferential direction. In this case, as a tap, the conductor preferably runs at right angles to the local circumferential direction and parallel to the longitudinal axis of the component.

According to a further embodiment of the method according to the invention, the step of adding a tap comprises the insertion of a supporting element which makes mechanical contact with the conductor.

The fundamental inventive concept, which comprises the conductor which forms the winding also being used to form a tap, is furthermore achieved by means of a winding apparatus which is designed to produce an electrical component according to the invention.

The inventive concept can furthermore be implemented by means of a control device which controls a controllable winding apparatus in such a manner that the method according to the invention is carried out. Particularly when using winding apparatuses whose movements are freely programmable, the inventive concept is achieved by the software which is designed to be able to run in a control device. This software can be provided in the form of a data storage medium, which interacts with the control device and the winding apparatus such that the method according to the invention is carried out and/or an electrical component according to the invention is produced. Depending on the control device and the winding apparatus, the software may therefore comprise commands in combination with movement parameters or only movement parameters, for example coordinates, speeds, vector details, acceleration information and/or associated control codes.

A copper or aluminum wire is preferably provided as a conductor, is mounted on a roll and is fed from this roll. The conductor furthermore comprises an external insulation layer, for example composed of plastic, glass-fiber fabric, carbon fabric, resin, in particular epoxy resin, or a combination thereof. In one preferred embodiment, the conductor is insulated with a sheath of thermal class H. The electrical component preferably comprises insulation for winding layers and/or external encapsulation of the winding comprising a glass-fiber-reinforced epoxy-resin molding material of thermal class F.

In a further embodiment, the electrical component is provided as a high-power transformer with a high-voltage side and a low-voltage side, with the low-voltage side comprising a low-voltage winding which is composed of aluminum or copper ribbon and, as turn insulation, has prepreg of thermal class F. In this embodiment, the high-voltage side and the low-voltage side of one phase can be arranged centrally on the same limb angle, with the winding associated with the low-voltage side being provided internally and being separated by a constant distance, by means of a low-voltage side insulation layer, a cooling channel and an inner high-voltage insulation layer, from the outer winding, which is associated with the high-voltage side. Instead of one high-voltage winding and/or low-voltage winding, there may be a plurality of high-voltage windings and/or low-voltage windings. The conductor preferably has a cross-sectional area of more than 0.5 mm², for example >1 mm², >2 mm² or 5-10 mm² In particular, the cross-sectional area is preferably between 10 mm² and 40 mm², 25 mm²-80 mm² or more than 80 mm² The cross-sectional area is designed to match the current flow and the heat development to be expected, depending on the rating and the field of use. In the case of power transformers, conductors are preferably used having a circular cross section and a conductor diameter of more than 0.75 mm, more than 1 mm, more than 1.5 mm, more than 2 mm or more than 3 mm on the high-voltage side.

The electrical component is preferably composed of self-quenching or fire-retardant materials, for example as conductor insulation and/or as an insulation intermediate layer.

The conductor within a winding may comprise conductor sections which are mechanically and/or electrically connected to one another, or may be formed from an integral conductor. The conductor preferably has a constant cross section, with the winding cross section preferably being round and, in the case of a ribbon winding, having a flat, rectangular cross section. Alternatively, the conductor may also be square or trapezoidal for a high-power transformer. The winding of the electrical component preferably has a rectangular cross section along the longitudinal axis. The cross section transversely with respect to the longitudinal axis of the winding is preferably circular. In the case of a rectangular yoke, the inside of the winding may be in the form of a rectangular column. The tangential outer surface of the winding is preferably cylindrical. In addition to the examples described above, the electrical component may be a transformer, an inductor, an electrical machine or electromagnet or else any other induction-based component, for example an induction-furnace coil or the like.

The electrical component according to the invention, or the winding of the component, is preferably in the form of a discrete element, which is physically separate from further circuit elements, components or windings.

In this application, the circumferential direction refers to the instantaneous local vector, that is to say the direction along which the conductor extends at the point under consideration. In the case of a cylindrical winding, the contact section extends along a circle section which extends over an angle of 0.5-5 degrees. The circumferential direction is therefore the tangent to the circle at the location at which the conductor is being considered. If the contact section extends over an angle range which is not negligible, then the winding of the conductor is continued in the direction at a location, for example at one end of the contact section, in which direction the tangent at this location extends, and not along the tangent along the opposite end of the contact section.

In this application, the profile of the conductor means the locus curve of the center line of the conductor. In the case of a circular cross section, this is the center point of the cross section, and in the case of rectangular conductors or conductors in the form of ribbons, this may be the center or an edge of the conductor.

### BRIEF DESCRIPTION OF THE DRAWINGS

The figures show embodiments which are designed according to the invention.

FIG. 1 shows a cross section through a winding of a component according to the invention on a section plane on which a longitudinal axis of the component runs.

FIG. 2 shows an electrical component according to the invention having an inner and an outer winding on a section plane at right angles to the longitudinal axis of the electrical component, with the inner and the outer winding each having a tap.

FIG. 3 shows the profile of a conductor along the contact section, in detail.

FIG. 4 shows a perspective view of a winding with two different taps.

### DETAILED DESCRIPTION

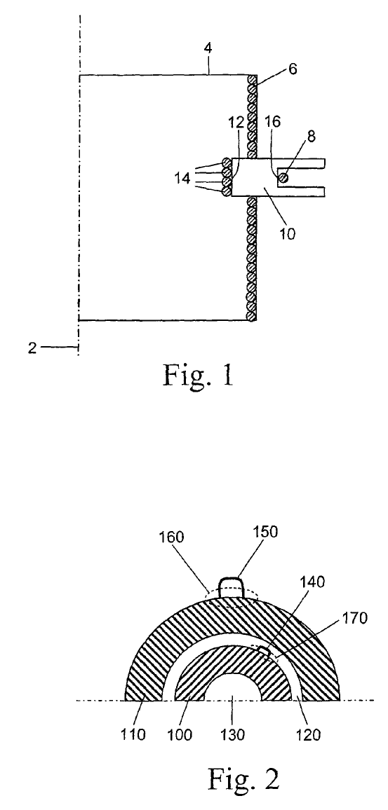

FIG. 1 shows a section view through an electrical component according to the invention on a section plane on which the longitudinal axis 2 of the electrical component is located. The external outline 4 of the winding is rectangular. As used herein, rectangular means essentially rectangular. The winding is formed from individual conductors 6, only some of which are illustrated which abut or are closest to the circumferential outer surface of the winding. FIG. 1 therefore shows a longitudinal section through a winding in the form of a column, for example a cylindrical or cuboid winding. A possible cavity in the interior of the winding, through which the longitudinal axis of the winding runs, is not illustrated.

The tap 8 is formed by a supporting element 10, which is formed from an insulator, for example plastic or ceramic. This supporting element is not completely circumferential but is provided only in a contact section and therefore covers only a small angle or a small proportion of a circumference. The supporting element 10 comprises a bottom surface 12 for support with respect to conductor turns 14 which are offset radially inwards, that is to say in the direction of the longitudinal axis. The supporting element is open radially on the outside in the form of a horizontal U. The supporting element 10 therefore comprises a supporting base 16, to which the tap 8 is fitted. The tap 8 merges at both ends of the contact section into a turn which is associated with deeper turn layers than the conductor turns 6, that is to say the supporting conductor turns 14 located underneath. In one embodiment, that turn which is associated with the tap 8 is the turn which is directly adjacent one of the two outer conductor turns of the supporting conductor turns 14, or directly precedes it.

No supporting element 10 is inserted before the conductor turns 14 are completed, and the outer tangential circumferential surface of the windings which have been partially completed in this way is flat and has no depression. For example, the supporting element 10 is inserted directly after completion of the uppermost of the conductor turns 14, and the turn which directly follows this passes through the supporting element 10 such that it is offset by a distance radially outwards, as a result of the distance between the supporting base 16 and the bottom surface 12. This automatically creates the inclination according to the invention of the conductor within the contact section with respect to the existing local circumferential direction, thus providing the tap according to the invention. In the embodiment illustrated in FIG. 1, within the contact section, the conductor forms a loop which is curved radially outwards, in which case the loop may also have sections which are additionally inclined in a direction parallel to the longitudinal axis 2.

The conductor turn 8 by means of which the tap has been formed in the contact section is followed by a further turn which is produced at the location of this conductor turn or follows it. This results in a homogeneous conductor density outside the supporting element. Further conductor turns are wound on until the desired number of conductors and/or radial thickness of the winding are/is achieved. As a result of the distance between the supporting surface 16 and the bottom surface 12, the tap 8 is radially further away from the longitudinal axis 2 of the component than the conductor turns of the outer turn layer 6.

In order to make contact with the tap, the tap is connected to a connecting conductor, for example by means of a soldered joint, a screw connection, a clamping connection or the like, with parts of the supporting element preferably being removed. However, according to the invention and in contrast to the prior art, this connecting conductor or tapping conductor is connected after completion of the winding process of at least one of the windings of the component.

FIG. 2 shows a cross section through an electrical component at right angles to its longitudinal axis. The electrical component has two windings 100, 110, which are arranged coaxially with respect to one another. A space 120 is provided between the inner winding 100 and the outer winding 110, with the inner winding 100 furthermore surrounding an internal area 130. A transformer leg or a yoke is preferably provided in the internal area 130. The intermediate space 120 between the inner winding 100 and the outer winding 110 is preferably used for cooling, and may have air-guidance grooves (not illustrated) in order to improve the convection, which grooves extend on planes which run radially parallel to the longitudinal axis of the component. The inner winding 100 has an inner tap 140 which extends into the intermediate space 120. In the same way, the outer winding 110 has an outer tap 150. The inner tap 140 is associated with a turn which is provided between the intermediate space 120 and the internal area 130 in the inner winding 100. In the same way, the tap 150 is associated with a turn which is located in the outer winding 110 between the intermediate space 120 and the exterior. The association of the taps with the respective turn is provided in such a manner that the conductor section which forms the tap merges directly into the associated turn.

The outer winding 110 has a contact section 160 in which the tap 150 is arranged. In the same way, the inner winding 100 has a contact section 170 in which the inner tap 140 is provided. The contact section corresponds only to a small proportion of an overall circumference of the winding, and therefore only to a section which is small in comparison to the overall circumference of the respective winding. Considered from the longitudinal axis of the concentric windings, the contact sections occupy only a small angle section, for example of less than 10 degrees, in particular of less than 5 degrees, and for example only 3-1 degrees or, particularly in the case of large electrical components with high powers, only 0.1-1 degrees, for example 0.2-0.5 degrees.

In an embodiment which is not illustrated but is similar to FIG. 2, the outer winding has a conductor loop which points radially inwards as a tap, which extends into the intermediate space 120. The tap on the outer winding is preferably offset with respect to the tap on the inner winding through an angle, for example through an angle of more than 10° or of more than 20°, or through an angle of about 45°, 60°, 90° or 180°.

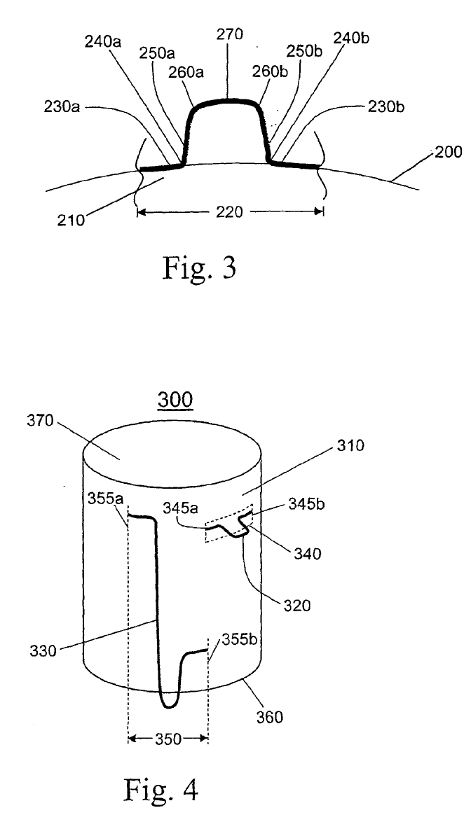

FIG. 3 shows a tap in cross section through a winding of an electrical component according to the invention, at right angles to the longitudinal axis of the winding, in detail.

FIG. 3 shows a section of an outline of a cylindrical winding 200. The tap 210 corresponds to a conductor turn within a contact section 220. The tap 210 has sections 230a, b, in which the conductor runs in a direction which is only slightly inclined with respect to the circumferential direction of the conductor outside the contact section. Furthermore, the tap 210 has bend areas 240a, b which are directly adjacent to the slightly inclined sections 230a, b and in which the conductor passes through a curvature of 70°-110°, for example 85°-95°. The radius of curvature is preferably chosen such that the cross section of the conductor is not significantly decreased and is, for example, 2-4 times or 3 times the conductor diameter. Adjacent to the bend areas 240a, b, there is a radial section 250a, b in which the conductor projects virtually at right angles from the winding surface. A final connecting part 270 is connected via two outer bend areas 260a, b, runs either in a straight line or curved corresponding to the other winding surfaces, and is preferably used for tapping.

The line annotated with the reference symbol 200 shows the line profile. Within the contact section 220, the line 200 shows the circumferential direction which a conductor would have at this point if it were a turn at this point, rather than a tap. The essence of the invention can also be defined in that, in the contact section to form the tap, the conductor leaves this imaginary line 200 which a turn that was present there would have and runs inclined with respect to this line 200, at least in places. The turn layers which are located above the contour line 200 are not shown, in order to improve the illustration. The turn layers located above this preferably do not go beyond the connecting part in the radial direction, in order to allow contact to be made with the tap 210 easily.

Alternatively, the conductor can be cut off at the point 270 and connected by means of a screw connection, soldered joint or clamping connection to connecting wires which are connected to one another within or outside the winding or the electrical component. In this case, the conductor turn which forms the tap is not a partially closed curve but only a turn piece which extends at right angles to the circumferential direction of adjacent winding sections. In this case, the conductor sections within the contact section extend at right angles to the winding surface or parallel to the winding surface 200, but in any case essentially at right angles to the circumferential direction of adjacent conductor sections or at an angle of 80°-100°, or about 90°, inclined with respect to the contour line 200, which represents the turn profile which would result if the section 220 were not a contact section. As used herein, right angles means essentially at right angles.

FIG. 4 shows an outline of a cylindrical winding with two different types of taps. A first tap 320 and a second tap 330 are arranged on the circumferential surface 310 of the winding 300. As in FIG. 3 as well, the taps in FIG. 4 are illustrated only to illustrate those elements which do not correspond completely to the normal winding profile, and the normal winding profile (circular tangentially around the center axis of the winding) is not shown, for clarity reasons.

The first tap 320 and the second tap 330 are each formed from the conductor from which the turns of the winding 300 are formed. Within a first contact section 340 and within a second contact section 350, this conductor, however, forms the first and the second taps 320, 330, respectively. Within the respective contact section 340 or 350, the conductor is inclined with respect to the circumferential direction to be expected there. In other words, the conductor departs from the circumferential direction to be expected for turns there between the respective ends 344a, b, 345a, b of the respective contact sections 350, 340, in order to form a tap in the form of a loop, which is inclined with respect to the circumferential direction. The inclination of the conductor with respect to the circumferential direction that exists on the contact section starts at the respective ends 345a, b, 355a, b of the respective contact section 350, 340, as a result of which the conductor departs from the normal tangential profile.

Within the first contact section, and in order to form the first tap 320, the conductor runs on the one hand at right angles to the circumferential direction and at least in places at right angles to the longitudinal axis of the winding. The tap 320 therefore projects radially from the winding. The taps 320 and 330 illustrated in FIG. 4 are concealed by the upper layers of the winding in the physical implementation of the embodiment shown in FIG. 4, but are illustrated completely for clarity purposes.

The second tap 330 likewise runs at right angles to the circumferential direction, to be expected in the contact section 350, of the conductor, but parallel to the longitudinal axis of the winding, in contrast to the first tap 320. The conductor which forms the tap 330 at one end 355a of the contact section 350 is arranged at a height with respect to the longitudinal axis of the winding which differs from the height of the conductor at the other end 355b of the contact section 350. In other words, at the entry of the contact section 355a to the exit of the conductor 355b from the contact section 350, the conductor is offset along the direction of the longitudinal axis of the winding. In an embodiment which is not illustrated, the entry point is offset with respect to the exit point by a different distance, or by a distance of 0. The tap 330 furthermore has a section which emerges from a bottom surface 360 of the winding, in order in this way to allow contact to be made easily.

In an embodiment which is not illustrated, this section projects out of the head surface 370 of the winding. The core or the internal area of the winding 300 may have a rectangular, square, ellipsoid or circular cross section.

In general, the tap may have conductor sections which are arranged parallel but in opposite directions with respect to one another, and are at a constant distance apart. This distance can be chosen to be as small as possible, as a result of which these two conductor sections abut directly on one another and are separated from one another only by the respective insulation layers. In one preferred embodiment, the two conductor sections are separated from one another by a spacer which makes mechanical contact with the two conductor sections and therefore has a supporting effect. The spacer may be formed from one or more parts. Furthermore, the spacer can make mechanical contact with the supporting element, for example the supporting element 10, for example via an interlocking and/or force-fitting connection. In one embodiment, the supporting element is formed integrally with the spacer. The spacer and/or the supporting element may have a partially interlocking depression or a clamping connection, which is designed to produce a friction lock with the connecting part 270 of the tap and/or of the line. The friction lock preferably has a variable connection strength in order to provide rigid fixing for the tap during the winding process and to provide only a small support for making contact with the tap after the winding process, in order to simplify the contact-making process. This can be achieved, for example, by means of a variable spring force of a section on the supporting element or spacer, with the section being opposite the connecting part 270 of the tap.

The embodiments illustrated in FIGS. 1-4 are not to scale. In particular, the dimensions of the taps, for example their width, the width of the contact section and the maximum distance between the tap and the conductor profile to be expected in the contact section, can be chosen freely. The circumferential direction of the conductor indicates the vector of the profile of the conductor, for example therefore not only the winding sense, that is to say the rotation direction of the profile of the conductor, but also the vectorial profile in three-dimensional space.

1-16. (canceled)

17. A power transformer comprises:
at least one winding formed from at least one conductor extending along a circumferential direction, wherein the at least one winding has a tap in a contact section formed by a profile of the at least one conductor in at least one direction inclined relative to the circumferential direction; and
at least one supporting element configured to support the conductor in the contact section.

18. The power transformer as recited in claim 17, wherein the profile of the at least one conductor corresponds to an at least partially closed curve.

19. The power transformer as recited in claim 18, wherein the at least partially closed curve has a section having an overall curvature between 270° and 360°.

20. The power transformer as recited in claim 17, wherein the profile of the conductor within the contact section is at a right angle to the profile of a portion of the conductor directly in front of the contact section and at a right angle or parallel to an axis of symmetry of the winding.

21. The power transformer as recited in claim 17, wherein the profile of the conductor directly after the contact section is offset by a distance from a profile of the conductor directly in front of the contact section in a direction parallel to an axis of symmetry of the winding.

22. A method for production of an electrical power transformer comprising:
providing a conductor;
winding the conductor along a circumferential direction around a rotation axis corresponding to an axis of symmetry of the electrical power transformer;
guiding the conductor in a direction inclined with respect to the circumferential direction so as to add a tap; and
adding a supporting element for the tap so as to form a mechanical contact between the supporting element and the conductor.

23. The method as recited in claim 22, wherein the guiding of the conductor includes guiding the conductor in a first direction at a right angle to the circumferential direction and at a right angle to the rotation axis and guiding the conductor in a second direction at a right angle to the circumferential direction and parallel to the rotation axis.

24. The method as recited in claim 22, wherein the guiding of the conductor includes guiding the conductor parallel to the rotation axis beyond a head end and wherein the winding of the conductor includes not passing the conductor beyond the head end.

25. The method as recited in claim 22, wherein the guiding of the conductor includes guiding the conductor at a right angle to the rotation axis over a radial distance and wherein the winding of the conductor includes not passing the conductor beyond the radial distance.

26. The method as recited in claim 22, wherein the winding the conductor includes a first winding step performed before the guiding the conductor, and a second winding step performed after the guiding the conductor.

27. A winding apparatus configured to produce a power transformer comprising:
a winding element configured to wind the conductor along a circumferential direction around a rotation axis corresponding to an axis of symmetry of the electrical power transformer;
a guiding element configured to guide the conductor in a direction inclined with respect to the circumferential direction so as to add a tap; and
a supporting element for the tap configured to form a mechanical contact between the supporting element and the conductor.

28. A control device for controlling a winding apparatus as recited in claim 27.
